(19) United States
(12) Patent Application Publication
(10) Pub. No.: US 2011/0202593 A1
(43) Pub. Date: Aug. 18, 2011

(54) FOCUSED SAMPLING OF TERMINAL REPORTS IN A WIRELESS COMMUNICATION NETWORK

(76) Inventors: Peter Vaderna, Budapest (HU); Gabor Magyar, Kecskemet (HU); Peter Benko, Budapest (HU); Andras Veres, Budapest (HU); Zsolt Kenesi, Budapest (HU)

(21) Appl. No.: 12/707,544

(22) Filed: Feb. 17, 2010

(51) Int. Cl. G06F 15/16

(52) U.S. Cl. 709/203; 709/224

(57) ABSTRACT

A performance management system and method are described herein that can control which client terminal(s) (e.g., mobile terminal(s)) are to provide Quality of Experience, QoE, report(s) and also control a level of detail for the requested QoE report(s).

### TECHNICAL FIELD

The present invention relates in general to the wireless telecommunications field and, in particular, to a performance management system and method for controlling which client terminal(s) are to provide a Quality of Experience, QoE, report and controlling a requested level of detail for the QoE report(s).

### BACKGROUND

The following abbreviations are herewith defined, at least some of which are referred to within the following description of the prior art and the present invention.

### 3GPP 3^{rd} Generation Partnership Project

### CN Core Network

### E2E End-to-End

### HTTP Hypertext Transfer Protocol

### ID Identification

### IP Internet Protocol

### OMA-DM Open Mobile Alliance-Device Management

### MBMS Multimedia Broadcast/Multicast Service

### PM Performance Management

### PSS Packet-switched Streaming Service

### QoE Quality of Experience

### RAN Radio Access Network

### RBS Radio Base Station

### RTCP Real-Time Transport Control Protocol

### RTP Real-Time Transport Protocol

### RTSP Real Time Streaming Protocol

### UMTS Universal Mobile Telecommunications System

### UTRAN UMTS Terrestrial Radio Access Network

Performance management is an important issue in wireless communication networks. Network operators should have feedback on the quality of the services they provide towards their users/subscribers. The network operators based on the feedback can take actions to assure that the agreed level of performance is reached. To fulfill this requirement, the network operators deploy a Performance Management (PM) system in the wireless communication network to control the performance monitoring, process the results, and act if performance degradation is detected.

The performance monitoring processes can be categorized into two main groups. The first group is known as network level monitoring where the performance data is collected in the network nodes/servers and sent to the PM system. Network level monitoring is performed via logging specific events in the nodes/servers or capturing and parsing data packets on aggregated interfaces. The PM system can process the measured raw data further to provide aggregated data (e.g. event counters, flow records, etc.). The advantage of network level monitoring is its flexibility and scalability, i.e. a few measurement points are sufficient to cover the whole area. The drawback of network level monitoring is that it is hard to obtain end-to-end (E2E) performance measurements for the individual client terminals.

The second group is known as terminal reporting where the performance data is collected by the client terminals themselves which make measurements related to the perceived quality and send the results to a server. The advantage of client terminal reporting is that it certainly provides E2E quality measurements. However, it is not feasible to request quality reports from all client terminals since this would impact the quality perceived by the users and also impact the network capacity and the server load.

In 3GPP networks the data available from network level monitoring for the PM system can be classified as follows (for example):
Information on performance such as download latency, throughput, packet loss, etc. for active client terminals.
Information on conditions such as location, radio environment, terminal type, cell/link congestion for active client terminals.

The above classification of PM data enables the PM system to localize problems/faults that occurred in the network and to perform root-cause analysis to find out the reasons of the problems/faults. For example, the performance degradation can be localized in certain cells or it might appear only for certain terminal types. Also, the performance degradation can be directly connected to poor radio conditions, inappropriate RBS/cell settings, congestion, bad terminal configuration, etc.

The PM system in addition to obtaining network level measurements should also be able to obtain information on performance from the terminal based measurements. There is a standard way of reporting terminal based measurements in the case of streaming media applications in 3GPP networks. In this case, an application server (e.g., PSS server, HTTP server, MBMS server) after negotiating the parameters of reporting with the client terminal will receive a Quality of Experience (QoE) report which is sent regularly from the client terminal. The following standardized services associated with streaming media have defined processes for the client terminals to send QoE reports to the application server:
Packet-switched Streaming Service (PSS) provides unicast on-demand streaming to client terminals. PSS is described in 3GPP TS 26.233, “Transparent end-to-end Packet Switched Streaming Service (PSS); General description (R8)” (the contents of this standard are incorporated herein by reference).
Multimedia Broadcast/Multicast Service (MBMS) provides broadcast streaming delivery to client terminals. MBMS is described in 3GPP TS 23.246, “Multimedia Broadcast/Multicast Service (MBMS)”; Architecture and functional description (R9)” (the contents of this standard are incorporated herein by reference).

In this document, the term application server and client terminal can mean either PSS application server and PSS client terminal or MBMS application server and MBMS client terminal.

In these two services, the main parameters such as rate, range, resolution of the QoE reports for different metrics are configured via an initial negotiation between the client terminal and the application server. According to prior art, the QoE reports are sent from the client terminal to the application server. The QoE reports on the application server are available for the PM system. The PM system fetches the QoE reports and uses them along with the existing network performance measurement results in fault localization and root-cause analysis. In the prior art, it is also up to the application server to decide which client terminals will send a QoE report and on what level. In particular, the application server controls and sets a percentage of the client terminals that will send the QoE reports and the level of details to provide in the QoE report. FIGS. 1-3 (PRIOR ART) and the corresponding text further describe the prior art related to the management of client terminal's QoE measurements.

Referring to FIG. 1 (PRIOR ART), there is a schematic diagram of a 3GPP network 100 illustrating RANs 102 which handle connections for client terminals 104, application servers 106 (e.g., PSS server 106a, HTTP server 106b, MBMS server 106c), and a CN 108 which connects the RANs 102 and the application servers 106 (the PM system is not shown). In this set-up, the communications 110 are between the application servers 106 and the client terminals 104. These communications 110 include the streaming session initiation, the QoE negotiation, the stream download, and the QoE reporting all of which are exchanged between each of the application servers 106 and their respective client terminals 104 through the RANs 102 and the CN 108. In the 3GPP PSS and MBMS solutions this communication scheme 110 is over RTCP/RTP/RTSP and/or HTTP protocols.

Referring to FIG. 2 (PRIOR ART), there is a schematic diagram of the 3GPP network 100 illustrating an optional OMA-DM 112 in addition to the RANs 102, client terminals 104, application servers 106 (e.g., PSS servers 106a, HTTP servers 106b, MBMS servers 106c), and CN 108 (the PM system is not shown). In this set-up, there are communications 114 (streaming session initiation, the stream download, and the QoE reporting) between the application servers 106 and the client terminals 104. Plus, there are some more communications 116 (QoE negotiation) between the OMA-DM 112 and the client terminals 104. A detailed discussion about the basic function of the OMA-DM 112 is provided in the following standard: OMA-ERELD-DM-V1_{—}2-20070209-A: “Enabler Release Definition for OMA Device Management Approved Version 1.2”. A detailed discussion about using the OMA-DM 112 in PSS and MBMS is provided in the following standards: (1) 3GPP TS 26.346, “Multimedia Broadcast/Multicast Service (MBMS)”; Protocols and codecs (R9); and (2) 3GPP TS 26.234, “Transparent end-to-end Packet Switched Streaming Service (PSS); Protocols and codecs (R9)”. The contents of these standards are incorporated herein by reference.

Referring to FIG. 3 (PRIOR ART), there is a schematic diagram of the 3GPP network 100 which now shows a PM system 118 along with the RANs 102, client terminals 104, application servers 106 (e.g., PSS servers 106a, HTTP servers 106b, MBMS servers 106c), the CN 108, and the optional OMA-DM 112. In this set-up, there are communications 120 (network measurement requests, network measurements) between the PM system 118 and the RANs 102 (UTRAN) and CN 108. Plus, there are communications 122 (QoE report fetch requests 122a, QoE reports 122b) between the PM system 118 and the application servers 106. The PM system 118 has full control over the network measurements in the RAN 102 and CN 108 however the PM system 118 can only fetch the QoE reports from the application servers 106 since it has no control over the terminal reporting measurements.

The PM system 118 needs the client terminal's QoE reports to help it perform the fault localization and root-cause analysis within the network 110. However, the PM system 118 does not have the control of the client terminal reporting measurements. The application server 106 has the control of the client terminal reporting measurements but it has no information on other network conditions to perform fault localization. This uncoordinated sampling significantly limits the possible use-cases of the PM system 118. For instance, since the application server 106 has to limit the amount of traffic caused by the client terminal's QoE reports by reducing the sampling ratio of the client terminals 104 that report QoE measurements. Plus, the PM system 118 for the same reason also limits the sampling ratio the high resolution node event reports that are requested from the RANs 102 and the CN 108. This means that there is no coordination between these samplings, thus the probability of properly matching QoE reports and network measurement reports is greatly reduced (i.e., if the sampling rates are 10%, the matching probability reduces to just 1%). Another problem with uncoordinated sampling is that the application server 106 will likely request to few client terminals 104 located in problematic areas, or terminal types etc. which otherwise should be providing QoE reports since the application server 106 is not focused on network management. Accordingly, there has been and is a need for enabling the PM system to control which client terminals are to provide QoE reports and also to control the level of detail in the QoE reports. This need and other needs have been satisfied by the present invention.

### SUMMARY

In one aspect of the present invention there is provided a method for performance management in a wireless communication network including at least a PM system, multiple client terminals, multiple network nodes, and an application server. The method is implemented by the PM system and includes the steps of: (1) selecting at least one client terminal to provide at least one QoE report; (2) determining a requested level of detail for the at least one QoE report; and (3) fetching the at least one QoE report from the application server after the at least one client terminal provides the at least one QoE report to the application server. An advantage of the method is that it enables the PM system to control which client terminals are to provide QoE reports and also control the level of detail in the QoE reports.

In another aspect of the present invention there is provided a PM system which includes: (1) a processor; and (2) a memory that stores processor-executable instructions where the processor interfaces with the memory and executes the processor-executable instructions to perform the following operations: (a) selecting at least one client terminal to provide at least one QoE report; (b) selecting a requested level of detail for the at least one QoE report which will be provided by the at least one client terminal; and (c) fetching the at least one QoE report from an application server after the at least one client terminal provides the at least one QoE report to the application server. Thus, the PM system controls which client terminals are to provide QoE reports and also controls the level of detail in the QoE reports.

In yet another aspect of the present invention there is provided a method for performance management in a wireless communication network including at least a PM system, multiple client terminals, multiple network nodes, and an application server. The method is implemented by the application server and includes the steps of (a) maintaining a media connected list of client terminals connected thereto; (b) maintaining a QoE settings list of the client terminals that have been requested to provide QoE reports together with a level of detail for the QoE reports; (c) maintaining a timer to control phasing out of the QoE setting list; (d) checking if the timer has expired; (i) if yes, emptying the QoE setting list; (ii) if no, checking if a connection changed event has occurred in which a connection was opened or closed to one of the client terminals; (iii) if yes, adding the one client terminal to the media connected list if the connection was opened or removing the one client terminal from the media connected list if the connection was closed and then sending an updated media connected list to the PM system; and (iv) if no connection changed event has occurred, checking if received a QoE update list from the performance management system and if yes then updating the QoE settings list according to the received QoE update list. This method enables the PM system to control which client terminals are to provide QoE reports and also control the level of detail in the QoE reports.

In yet another aspect of the present invention there is provided an application server which includes: (1) a processor; and (2) a memory that stores processor-executable instructions where the processor interfaces with the memory and executes the processor-executable instructions to perform the following operations: (a) maintaining a media connected list of client terminals connected thereto; (b) maintaining a QoE settings list of the client terminals that have been requested to provide QoE reports together with a level of detail for the QoE reports; (c) maintaining a timer to control phasing out of the QoE setting list; (d) checking if the timer has expired; (i) if yes, emptying the QoE setting list; (ii) if no, checking if a connection changed event has occurred in which a connection was opened or closed to one of the client terminals; (iii) if yes, adding the one client terminal to the media connected list if the connection was opened or removing the one client terminal from the media connected list if the connection was closed and then sending an updated media connected list to the PM system; and (iv) if no connection changed event has occurred, checking if received a QoE update list from the PM system and if yes then updating the QoE settings list according to the received QoE update list. This enables the PM system to control which client terminals are to provide QoE reports and also control the level of detail in the QoE reports.

In still yet another aspect of the present invention there is provided a method for performance management in a wireless communication network including at least a PM system, multiple client terminals, multiple network nodes, and an application server. The method is implemented by the application server and includes the steps of: (1) sending a message to the PM system, where the message contains a request for a QoE specification of a specific client terminal currently connected thereto; and (2) receiving a response from the PM system, where the response indicates that the specific client terminal is to provide a QoE report and a requested level of detail for the QoE report. This method enables the PM system to control which client terminals are to provide QoE reports and also control the level of detail in the QoE reports.

In yet another aspect of the present invention there is provided an application server which includes: (1) a processor; and (2) a memory that stores processor-executable instructions where the processor interfaces with the memory and executes the processor-executable instructions to perform the following operations: (i) sending a message to a PM system, where the message contains a request for a QoE specification of a specific client terminal currently connected thereto; and (ii) receiving a response from the PM system, where the response indicates that the specific client terminal is to provide a QoE report and a requested level of detail for the QoE report. This enables the PM system to control which client terminals are to provide QoE reports and also control the level of detail in the QoE reports.

In still yet another aspect of the present invention there is provided a method for performance management in a wireless communication network including at least a PM system, multiple client terminals, multiple network nodes, an application server, and an OMA-DM system. The method is implemented by the OMA-DM system and includes the steps of: (1) receiving a message from the PM system, where the message indicates at least one client terminal which is to provide at least one QoE report and the requested level of detail for the at least one QoE report; and (2) negotiating with the at least one client terminal to determine metrics of the requested level of detail for the at least one QoE report. This method enables the PM system to control which client terminals are to provide QoE reports and also control the level of detail in the QoE reports.

In still yet another aspect of the present invention there is provided an OMA-DM system which includes: (1) a processor; and (2) a memory that stores processor-executable instructions where the processor interfaces with the memory and executes the processor-executable instructions to perform the following operations: (i) receiving a message from a PM system, where the message indicates at least one client terminal which is to provide at least one QoE report and the requested level of detail for the at least one QoE report; and (ii) negotiating with the at least one client terminal to determine metrics of the requested level of detail for the at least one QoE report. This enables the PM system to control which client terminals are to provide QoE reports and also control the level of detail in the QoE reports.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings:

FIGS. 1-3 (PRIOR ART) are block diagrams of an exemplary 3GPP network used to explain the current state of the art and the drawbacks that a traditional PM system has related to the management of client terminal based measurements;

FIG. 4 is a schematic diagram of a 3GPP network which is used to explain how an enhanced PM system can interact with multiple RANs, a CN, and an application server to control client terminal based measurements;

FIG. 5 is a schematic diagram of a 3GPP network which is used to explain how an enhanced PM system can interact with multiple RANs, a CN, an OMA-DM and an application server to control client terminal based measurements;

FIGS. 6-11 are message flow diagrams and flow charts used to explain in more detail how an enhanced PM system can interact with multiple RANs, a CN, an application server, and possibly an OMA-DM to control client terminal based measurements; and

FIGS. 12-13 are message flow diagrams used to explain in more detail some more ways how an enhanced PM system can interact with multiple RANs, a CN, an application server, and possibly an OMA-DM to control client terminal based measurements.

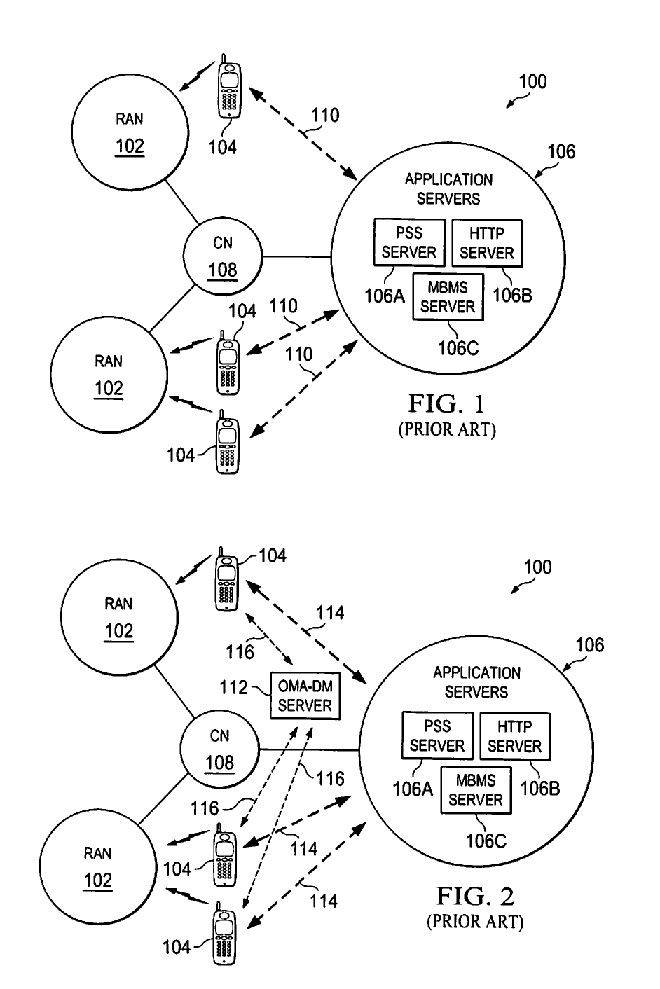

### DETAILED DESCRIPTION

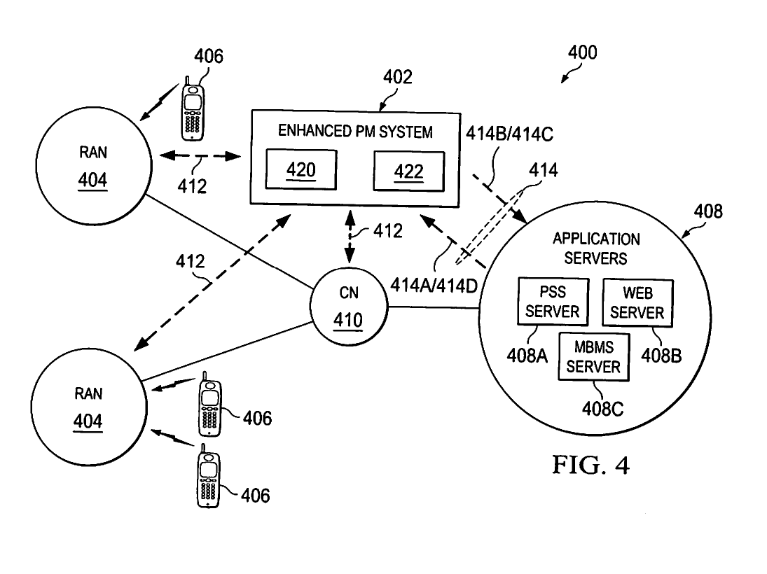

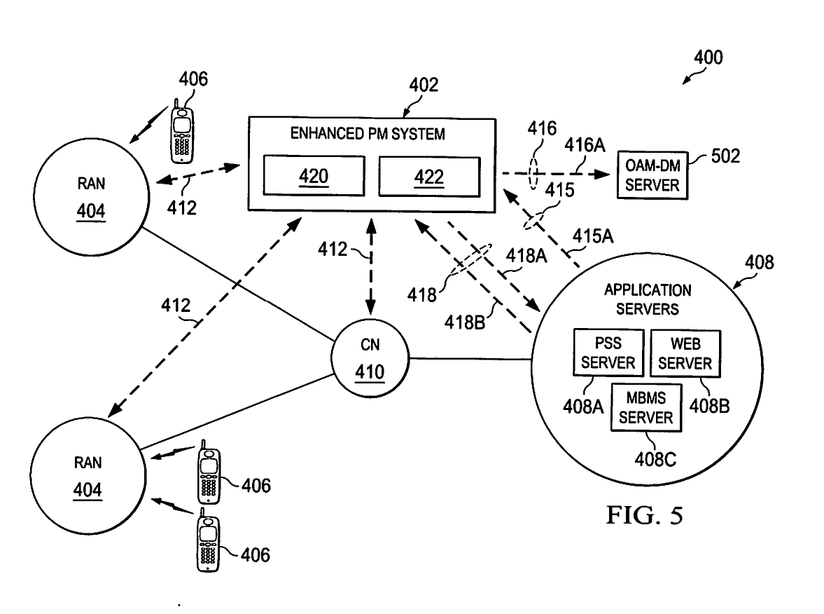

In the present invention, there is an enhanced PM system that controls which set of client terminals are to report (focused sampling) and the level of details of QoE reporting. The enhanced PM system can collect information on user performance from network level measurements and build-up a filtering rule set and based on this rule set and the network level measurements identify the client terminals which match the criteria and then requests the application server to have this set of client terminals provide QoE reports and the level of details of the QoE reports. The enhanced PM system does this by exchanging relevant data with the application server which collects the QoE reports. To achieve this, a communication scheme between the enhanced PM system and the application server is established (see FIGS. 4, 6, and 8-12). If the QoE reporting is controlled by an OMA-DM, the enhanced PM system would then make the client terminal and QoE settings requests with the OMA-DM (see FIGS. 5, 7 and 13).

Since, the enhanced PM system can decide on the sampling focus, it will be capable of receiving client terminal's QoE reports from problematic areas, terminals, etc. For example, if the enhanced PM system is invoked to perform a detailed test focusing on a certain territory (e.g. particular cells, RBSs) then an algorithm is switched on that identifies all client terminals (via client IDs, e.g. IP addresses) initiating media streaming sessions from the investigated territory and then requests more detailed QoE reports from those client terminals. Similarly, the enhanced PM system can focus on certain terminal types or certain radio or traffic conditions. A detailed discussion about several different ways that the enhanced PM system can be configured and used to accomplish all of this has been provided below with respect to FIGS. 4-13.

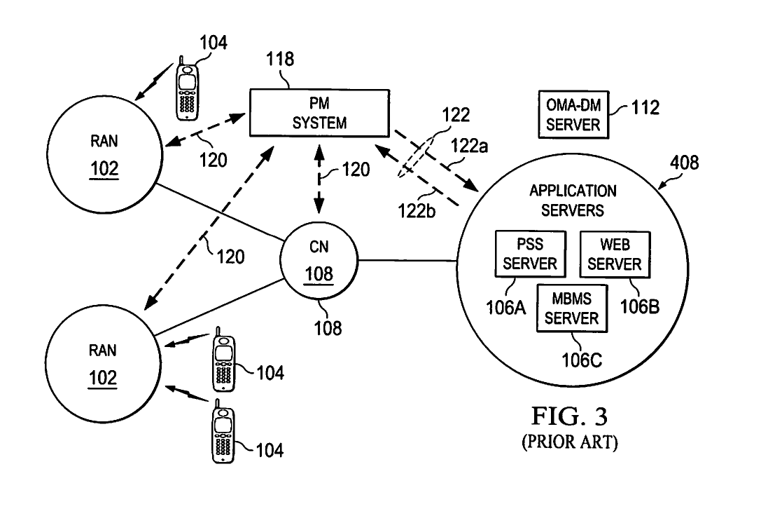

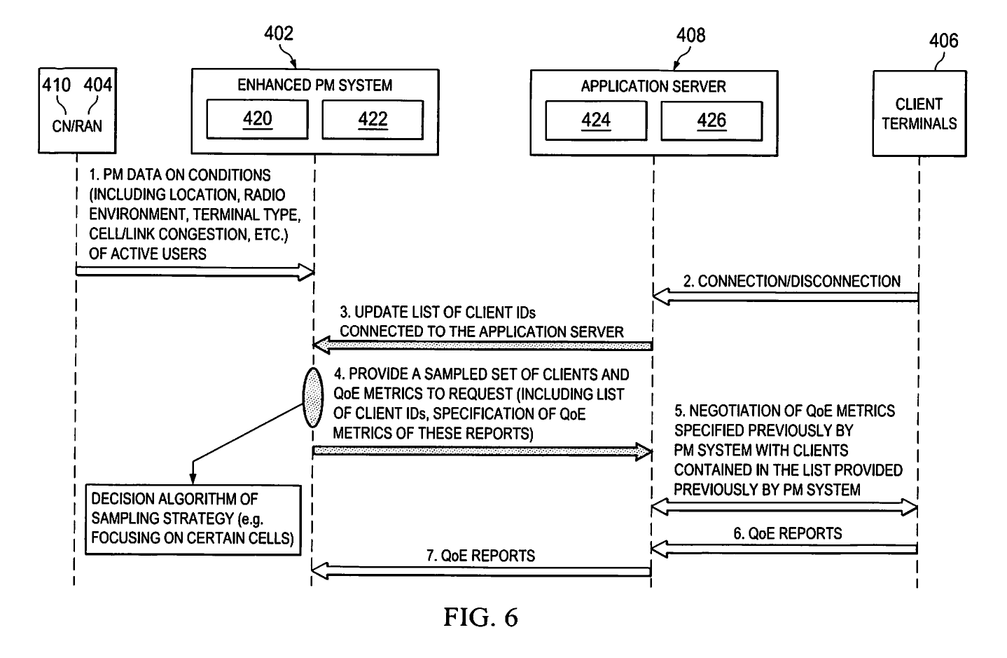

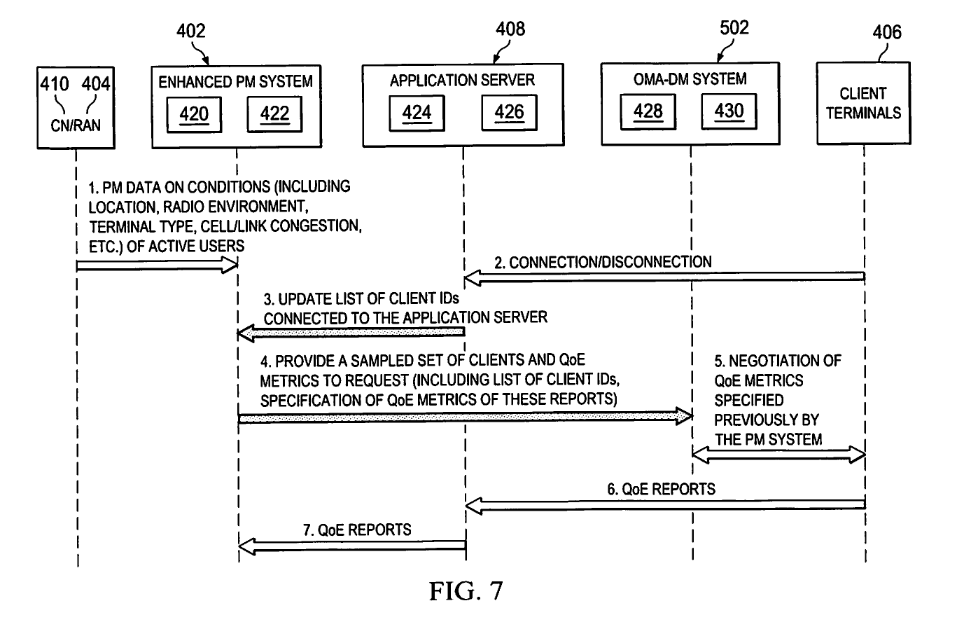

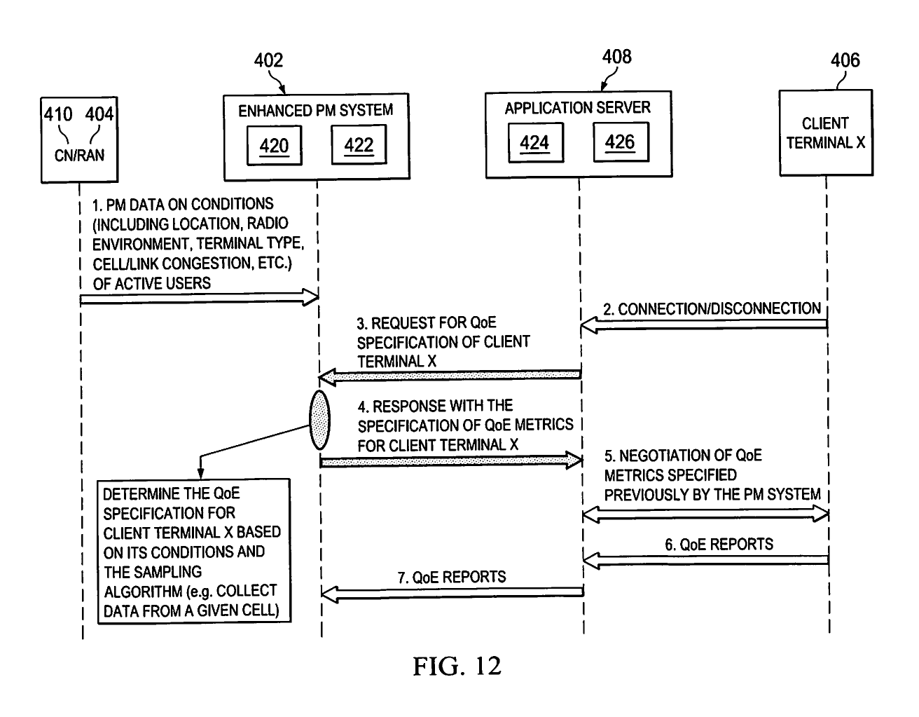

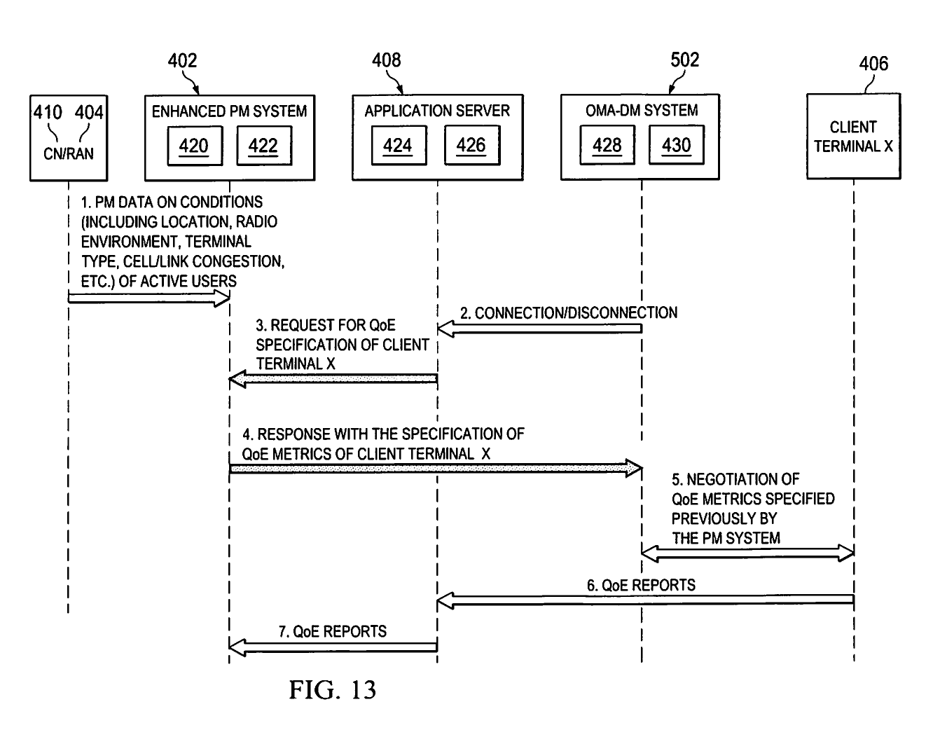

Referring to FIG. 4, there is a schematic diagram of a 3GPP network 400 illustrating an enhanced PM system 402, multiple RANs 404, multiple client terminals 406, application servers 408 (e.g., PSS server 408a, HTTP server 408b, MBMS server 408c), and a CN 410. The RANs 404 handle the connections for the client terminals 406 while the CN 410 connects the RANs 404 to the application servers 408. In this set-up, the PM system 402 has communications 412 (network measurement requests, network measurements) with the RANs 404 (UTRAN) and CN 410. Plus, the PM system 402 has communications 414 (connected message 414a, control message 414b, QoE report fetch requests 414c, QoE reports 414d) with the application servers 408 (compare to FIG. 3). The connected message 414a can indicate the client terminals 406 that are currently connected to the application server 408 (see FIG. 6-7). Or, the connected message 414a can indicate when one client terminal 406 recently connected to the application server 408 (see FIGS. 12-13). The control message 414b indicates the specific client terminal(s) 406 which is/are to provide QoE report(s) and the requested level of detail for the QoE report(s). Thus, the PM system 402 has full control over the network measurements in the RAN 404 and CN 410 and full control over the client terminal reporting measurements in that the application server 408 is instructed to have specific client terminal(s) provide QoE report(s) and the level of detail in those QoE report(s).

Referring to FIG. 5, there is a schematic diagram of a 3GPP network 400 illustrating the enhanced PM system 402, an optional OMA-DM 502, multiple RANs 404, multiple client terminals 406, application servers 408 (e.g., PSS server 408a, HTTP server 408b, MBMS server 408c), and a CN 410. The RANs 404 handle the connections for the client terminals 406 while the CN 410 connects the RANs 404 to the application servers 408. In this set-up, the enhanced PM system 402 has communications 412 (network measurement requests, network measurements) with the RANs 102 (UTRAN) and CN 108. The PM system 402 has communications 415 (connected message 415a) with the application server 408. The connected message 415a can indicate the client terminals 406 that are currently connected to the application server 408 (see FIG. 6-7). Or, the connected message 415a can indicate when one client terminal 406 recently connected to the application server 408 (see FIGS. 12-13). The PM system 402 has communications 416 (control message 416a) with the OMA-DM 502. The control message 416a indicates the specific client terminal(s) 406 which is/are to provide QoE report(s) and the requested level of detail for the QoE report(s). Plus, the PM system 402 has communications 418 (QoE report fetch requests 418a, QoE reports 418b) with the application servers 408 (compare to FIG. 3). Thus, the PM system 402 has full control over the network measurements in the RAN 404 and CN 410 and full control over the client terminal reporting measurements in that the OMA-DM 502 is instructed to have specific client terminal(s) provide QoE report(s) and the level of detail in those QoE report(s).

In the discussions below, there are provided two different scenarios which are used to explain in detail how the PM system 402 has full control over the client terminal reporting measurements by communicating with the application server 408 (see FIG. 4) or by communicating with both the application server 408 and the OMA-DM 502 (see FIG. 5). In the first scenario, the communication between the PM system 402 and the application server 408 and if present the OMA-DM 502 is based on exchanging regular updates of a list of client terminals 406 connected to the application server 408 and a list identifying the set of clients terminal selected to provide QoE reports and the level of detail to be provided in those QoE reports (see FIGS. 6-11). In the second scenario, the communication between the PM system 402 and the application server 408 and if present the OMA-DM 502 is based on fixed scheduling where the application server 408 exchanges information with the PM system 402 for each one of the recently connected client terminals 406 (see FIGS. 12-13).

Referring to FIG. 6, there is a message sequence chart indicating the communications between the PM system 402, the application server 408, the CN 410/RAN 404, and the client terminals 406 in accordance with an embodiment of the present invention. In this discussion, it should be understood that the application server 408 can be connected to multiple client terminals 406 and the PM system 402 can be connected to multiple CNs 410/RANs 404. Plus, the arrows do not necessarily represent single messages but message sequences related to the subject of that specification communication. The white arrows represent those messages or message sequences that exist with the traditional PM system. The dark arrows represent those messages or message sequences that have been introduced in accordance with the present invention. The following messages or message sequences can be exchanged within the 3GPP network 400:

1. The PM system 402 requests and receives relevant network measurement data from local stores of the RAN 404 or CN 410 (see communications 412 in FIG. 4). The PM system 402 might be considered as a system covering the whole network 400, which includes monitoring functions, data storage, processing utilities and all functions needed to monitor performance, process the results and act if performance degradation is detected. In this case, this message or message sequence is not necessary and it is assumed that the PM system 402 already has the relevant data (including network measurements) it needs to make the decision on the sampled client terminals 406 and the level of details of QoE reports.

2. The client terminals 406 initiate new connections or terminate their existing connections to the application server 408.

3. The application server 408 provides an update on the IDs of those client terminals 406 connected to it (see connected message 414a in FIG. 4). The scheduling to of this message is configurable. For instance, this message can be a regular update.

4. The PM node 402 provides the application server 408 with the IDs of a sampled set of the connected client terminals 406 to request QoE reports from (see message 414b in FIG. 4). The list also contains the requested level of details of the QoE reports. The scheduling of this message is configurable. For instance, this message can be a regular update.

5. Negotiation of QoE metrics occurs between the selected client terminals 406 and the application server 408. These communications can be based on RTSP and SDP protocols.

6. The selected client terminals 406 send their QoE reports to the application server 408 periodically according to the QoE metric setup that was negotiated in message no. 5. This communication is based on RTSP or HTTP depending on the system 400 (PSS, MBMS).

7. The PM system 402 fetches the QoE reports from the application server 408 (see messages 414c and 414d in FIG. 4).

The PM system 402 includes one or more processors 420 and at least one memory 422 (storage 422) that has processor-executable instructions where the processor(s) 420 are adapted to interface with the at least one memory 422 and execute the processor-executable instructions to receive messages 1 and 3 and process those messages to determine a sampling strategy and to provide a list of the sampled set of client terminals 406 and requested QoE metrics to the application server 408 in message 4 and then receive the sampled client terminal's QoE reports in message 7 from the application server 408 (note: the one or more processors 420 and the at least one memory 422 can be implemented, at least partially, as software, firmware, hardware, or hard-coded logic).

The applicant server 408 includes one or more processors 424 and at least one memory 426 (storage 426) that has processor-executable instructions where the processor(s) 424 are adapted to interface with the at least one memory 426 and execute the processor-executable instructions to receive message 2 which contains client terminal connection-disconnection information and send message 3 to the PM system 402 to update the list of the connected client terminals and then receive message 4 from the PM system 402 so know which client terminals 406 to negotiate the QoE metrics with during message 5 and then receive their QoE reports in message 6 and forward those QoE reports to the PM system 402 in message 7.

Referring to FIG. 7, there is a message sequence chart indicating the communications between the PM system 402, the application server 408, the OMA-DM 502, the CN 410/RAN 404, and the client terminals 406 in accordance with an embodiment of the present invention. In this discussion, it should be understood that the application server 408 and the OMA-DM 502 can be connected to multiple client terminals 406 and the PM system 402 can be connected to multiple CNs 410/RANs 404. Plus, the arrows do not necessarily represent single messages but message sequences related to the subject of that specification communication. The white arrows represent those messages or message sequences that exist with the traditional PM system. The dark arrows represent those messages or message sequences that have been introduced in accordance with the present invention. The following messages or message sequences can be exchanged within the 3GPP network 400:

1. The PM system 402 requests and receives relevant network measurement data from local stores of the RAN 404 or CN 410 (see communication 412 in FIG. 5). The PM system 402 might be considered as a system covering the whole network 400, which includes monitoring functions, data storage, processing utilities and all functions needed to monitor performance, process the results and act if performance degradation is detected. In this case, this message or message sequence is not necessary and it is assumed that the PM system 402 already has the relevant data (including network measurements) it needs to make the decision on the sampled client terminals 406 and the level of details of QoE reports.

2. The client terminals 406 initiate new connections or terminate their existing connections to the application server 408.

3. The application server 408 provides an update on the IDs of those client terminals 406 connected to it (see list message 415a in FIG. 5). The scheduling of this message is configurable. For instance, this message can be a regular update.

4. The PM node 402 provides the OMA-DM 502 with the IDs of a sampled set of the connected client terminals 406 to request QoE reports from (see control message 416a in FIG. 5). The list also contains the requested level of details of the QoE reports. The scheduling of this message is configurable. For instance, this message can be a regular update.

5. Negotiation of QoE metrics occurs between the selected client terminals 406 and the OMA-DM 502. These communications can be based on RTSP and SDP protocols.

6. The selected client terminals 406 send their QoE reports to the application server 408 periodically according to the QoE metric setup that was negotiated in message no. 5. This communication is based on RTSP or HTTP depending on the system 400 (PSS, MBMS or OMA-DM).

7. The PM system 402 fetches the QoE reports from the application server 408 (see messages 418a and 418b in FIG. 5).

The PM system 402 includes one or more processors 420 and at least one memory 422 (storage 422) that includes processor-executable instructions where the processor(s) 420 are adapted to interface with the at least one memory 422 and execute the processor-executable instructions to receive messages 1 and 3 and process those messages to determine a sampling strategy and to provide a sampled set of client terminals 406 and requested QoE metrics to the OMA-DM 502 in message 4 and then receive the sampled client terminal's QoE reports in message 7 from the application server 408 (note: the one or more processors 420 and the at least one memory 422 can be implemented, at least partially, as software, firmware, hardware, or hard-coded logic).

The OMA-DM 502 includes one or more processors 428 and at least one memory 430 (storage 430) that has processor-executable instructions where the processor(s) 428 are adapted to interface with the at least one memory 430 and execute the processor-executable instructions to receive message 4 which indicates the set of client terminal 406 to provide QoE reports and the requested level of detail for the QoE reports from the PM system 402 and then in message 5 negotiates with the sampled client terminals 406 to determine to metrics for the QoE reports. This enables the PM system 402 to control which client terminals 406 are to provide QoE reports and also control the level of detail in the QoE reports.

In FIGS. 6-7, the new messages 3 and 4 that have been described aim at updating the set of client terminals 406 and the level of details of QoE reports at the application server 408 or OMA-DM 502. In this regard, the following data could be maintained in the PM system 402, the application server 408 and if used the OMA-DM 502:
media_connected_list: a list of the client terminal IDs connected to the application server 408. Optionally, timestamps indicating the start of the connections can be stored in this list to be able to phase out old inactive connections.
qoe_settings_list: a list of the client terminal IDs to request QoE reports from, together with the QoE metrics settings. The QoE metrics contain all of the information that is needed for the QoE negotiations with the client terminals 406 embedded in an RTSP message.

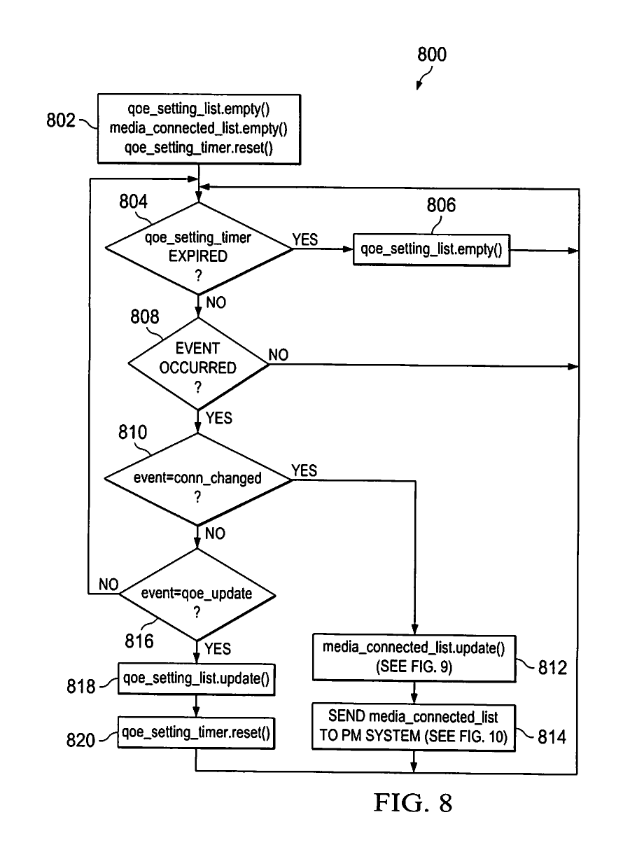

A discussion about an exemplary scheme that can be used to update of the above lists (media_connected_list, qoe_settings_list) in both the PM system 402 and the application server 408 will be provided next with respect to FIGS. 8-11.

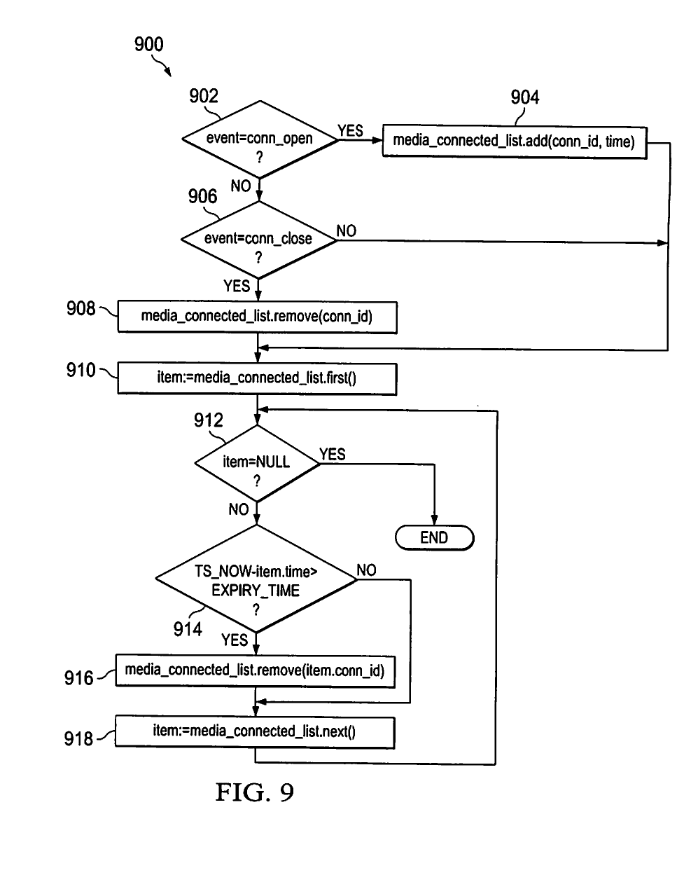

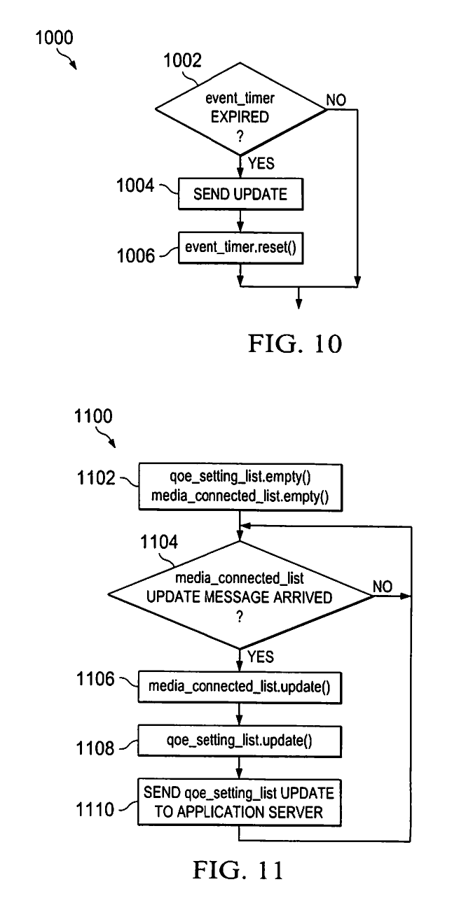

Referring to FIG. 8, there is a flowchart indicating a method 800 that can be implemented by the application server 408 to update the media_connected_list, qoe_settings_list in accordance with an embodiment of the present invention. In step 802, the application server 408 is initialized to maintain the above lists (media_connected_list, qoe_settings_list) and also maintain a timer (qoe_setting_timer) to control the phasing out of a too old qoe_setting_list. In step 804, the application server 408 checks if the qoe_setting_timer has expired. If the qoe_setting_timer has expired at step 804, then the application server 408 at step 806 empties the qoe_setting_list and starts the loop again by returning to step 804. If the qoe_setting_timer has not expired at step 804, then the application server 408 at step 808 checks if an event occurred where an event can include either a conn_changed (meaning successful connection open/close from the client terminal(s) 406) or a qoe_update (coming from the PM system 402). If the result of step 808 is no, then the application server 408 starts the loop again by returning to step 804. If the result of step 808 is yes, then the application server 408 at step 810 checks if a connection change event has occurred in which a connection was opened or closed to one of the client terminals 406. If the result of step 810 is yes, then the application server 408 at step 812 updates the media_connected_list and at step 814 sends the updated media_connected_list to the PM system 402. The updating step 812 includes adding new Client IDs to the media_connected_list if new connection(s) are opened and optionally adding the timestamp indicating the time of the connection initiation. In addition, the updating step 812 includes removing the Client IDs from the media_connected_list if their connection is closed. In step 812, if desired old items (after timer expiration) can be removed from the media_connected_list (see FIG. 9). Alternatively, in step 814 the application server 408 can periodically (after time expiration) send the updated media_connected_list to the PM system 402 (see FIG. 10). If the result of step 810 is no, then the application server 408 at step 816 checks if a qoe_update event occurred. If the result of step 816 is no, then the application server 408 starts the loop again by returning to step 804. If the result of step 816 is yes, then the application server 408 at step 818 updates the qoe_setting_list according to the message received from the PM system 402. Then, the application server 408 at step 820 resets the qoe_setting_timer and starts the loop again by returning to step 804.

Referring to FIG. 9, there is a flowchart indicating an optional method 900 that can be used to remove old items from the media_connected_list during the updating step 812 in method 800 in accordance with an embodiment of the present invention. In step 902, the application server 408 checks if a connection change event has occurred in which a connection for a client terminal 406 was opened. If the result of step 902 is yes, then the application server 408 at step 904 adds the Client ID of the newly connected client terminal 406 to the media_connected_list and also adds a timestamp indicating the time of the new connection. If the result of step 902 is no, then the application server 408 at step 906 checks if a connection change event has occurred in which a connection for a client terminal 406 was closed. If the result of step 906 is yes, then the application server 408 at step 908 removes the Client ID of the newly disconnected client terminal 406 from the media_connected_list. If the result of step 906 is no or after steps 904 and 908, the application server 408 at step 910 takes the updated media_connected_list and at step 912 checks to see if there is a client terminal 406 currently in the updated media_connected_list. If the result of step 912 is yes, then the application server 408 is done updating the media_connected_list and proceeds to step 814 in FIG. 8. If the result of step 912 is no, then the application server 408 at step 914 checks if the current time (TS_NOW) is greater than an expiry time in view of the timestamps of the connected client terminal 406. If the result of step 914 is yes, then the application server 408 at step 916 removes the client terminal that has an expired timestamp from the media_connected_list. If the result of step 914 is no or after step 916, the application server 408 at step 918 checks the updated media_connected_list for the next client terminal 406 and loops back to step 912.

Referring to FIG. 10, there is a flowchart indicating an optional method 1000 that can be used to periodically (after time expiration) send the updated media_connected_list to the PM system 402 which is an alternative to step 814 of method 800 in accordance with an embodiment of the present invention. At step 1002, the application server 408 uses an event_timer and checks to see if the timer expired. If the result of step 1002 is yes, then the application server 408 at step 1004 sends the updated media_connected_list to the PM system 402 and then at step 1006 resets the event_timer and proceeds to step 804 in method 800 of FIG. 8. If the result of step 1002 is no, then the application server 408 does not send the updated media_connected_list to the PM system 402 but instead proceeds to step 804 in method 800 of FIG. 8. In this way, the application server 408 by implementing method 1000 helps to avoid overloading the network 400 by periodically sending the updated media_connected_list to the PM system 402.

Referring to FIG. 11, there is a flowchart indicating a method 1100 that can be implemented by the PM system 402 to control the qoe_setting_list in accordance with an embodiment of the present invention. In step 1102, the PM system 402 is initialized to maintain the media_connected_list and the qoe_settings_list. At step 1104, the PM system 402 checks if an updated media_connected_list has been received from the application server 408. If the result of step 1104 is no, then the PM system 402 loops back and repeats step 1104. If the result of step 1104 is yes, then the PM system 402 at step 1106 updates it's media_connected_list to match the received media_connected_list. The PM system 402 then at step 1108 processes the newly updated media_connected_list and generates the updated qoe_setting_list which indicates the client terminals 406 that are to provide QoE reports and the level of detail of the QoE reports. For instance, the PM system 402 can implement an internal process to generate the updated qoe_setting_list using network performance data, the updated media_connected_list and the old qoe_setting_list. As an example, the PM system 402 can update the qoe_setting_list based on a default method (e.g. setting of given % of client terminals 406 to sample) or it can focus on certain areas (e.g. put those client terminal IDs into the updated qoe_setting_list where the respective client terminals 406 are located in the same cell, or using the same terminal type or subscription, etc). Thereafter at step 1110, the PM system 402 sends the updated qoe_setting_list to the application server 408. If desired, the sending of the updated qoe_setting_list can be delayed by using a timer in a similar manner that the application server 406 can delay sending the updated media_connected_list as described in FIG. 10.

Referring to FIG. 12, there is a message sequence chart indicating the communications between the PM system 402, the application server 408, the CN 410/RAN 404, and the client terminals 406 in accordance with an embodiment of the present invention. As discussed below, right after a client terminal 406 (client terminal X) initiates a connection, the application server 408 requests details about the preferred QoE settings for that client terminal from the PM system 402. Then, the PM system 402 based on an actual sampling algorithm (e.g. collect data from a given cell) makes a decision on whether to have that client terminal X provide the QoE report and the level of details in the QoE report. Thereafter, the PM system 402 sends a response containing its preferred QoE metrics for client terminal X to the application server 402. The application server 408 should wait for the response from the PM system 402 before starting the QoE negotiations of QoE metrics with client terminal X. An advantage of this fixed scheduling is that the QoE negotiations are finished with the preferred settings before the start of the streaming session. This process can be better understood with reference to the following discussion about the messages or message sequences that can be exchanged within the 3GPP network 400:

1. The PM system 402 requests and receives relevant network measurement data from local stores of the RAN 404 or CN 410 (see comment 412 in FIG. 4). The PM system 402 might be considered as a system covering the whole network 400, which includes monitoring functions, data storage, processing utilities and all functions needed to monitor performance, process the results and act if performance degradation is detected. In this case, this message or message sequence is not necessary and it is assumed that the PM system 402 already has the relevant data (including network measurements) it needs to make the decision on the sampled client terminals 406 and the level of details of QoE reports.

2. The client terminal 406 (client terminal X) initiates a new connection or terminates their existing connection to the application server 408.

3. The application server 408 sends a message to the PM system 402 requesting a QoE specification of client terminal X (see connected message 414a in FIG. 4).

4. The PM node 402 sends the application server 408 a response indicating the specification of the QoE metrics for client terminal X after determining the preferred QoE metrics for client terminal X based on the conditions of client terminal X and the sampling algorithm (see control message 414b in FIG. 4).

5. Negotiation of QoE metrics occurs between the application server 408 and client terminal X. In one case, the application server 408 can start the QoE negotiation after a timeout expires even if the response from the PM system 402 has not arrived so as not to affect the performance of client terminal X. These communications can be based on RTSP and SDP protocols.

6. Client terminal X sends their QoE report to the application server 408 periodically according to the QoE metric setup that was negotiated in message no. 5. This communication is based on RTSP or HTTP depending on the system 400 (PSS, MBMS).

7. The PM system 402 fetches the QoE report from the application server 408 (see messages 414c and 414d in FIG. 4).

FIG. 12's arrows do not necessarily represent single messages but message sequences related to the subject of that specification communication. The white arrows represent those messages or message sequences that exist with the traditional PM system. The dark arrows represent those messages or message sequences that have been introduced in accordance with the present invention.

The PM system 402 includes one or more processors 420 and at least one memory 422 (storage 422) that has processor-executable instructions where the processor(s) 420 are adapted to interface with the at least one memory 422 and execute the processor-executable instructions to receive messages 1 and 3 and process those messages to determine a sampling strategy and to provide requested QoE metrics for client terminal X to the application server 408 in message 4 and then receive the sampled client terminal X's QoE report (and other sampled client terminal's QoE reports) in message 7 from the application server 408 (note: the one or more processors 420 and the at least one memory 422 can be implemented, at least partially, as software, firmware, hardware, or hard-coded logic).

The applicant server 408 includes one or more processors 424 and at least one memory 426 (storage 426) that has processor-executable instructions where the processor(s) 424 are adapted to interface with the at least one memory 426 and execute the processor-executable instructions to receive message 2 when client terminal X connects thereto and send the PM system 402 message 3 which contains a request for a QoE specification for client terminal X and then receive a reply in message 4 from the PM system 402 so can negotiate the QoE metrics in message 5 with client terminal X and then receive the QoE report in message 6 and forward the QoE report to the PM system 402 in message 7. This enables the PM system 402 to control which client terminals 406 are to provide QoE reports and also control the level of detail in the QoE reports.

Referring to FIG. 13, there is a message sequence chart indicating the communications between the PM system 402, the application server 408, the OMA-DM 502, the CN 410/RAN 404, and the client terminals 406 in accordance with an embodiment of the present invention. As discussed below, right after a client terminal 406 (client terminal X) initiates a connection, the application server 408 requests details about the preferred QoE settings for that client terminal from the PM system 402. Then, the PM system 402 based on an actual sampling algorithm (e.g. collect data from a given cell) makes a decision on whether to have that client terminal X provide the QoE report and the level of details in the QoE report. Thereafter, the PM system 402 sends a response containing its preferred QoE metrics for client terminal X to the OMA-DM 502. The OMA-DM 502 should wait for the response from the PM system 402 before starting the QoE negotiations of QoE metrics with client terminal X. An advantage of this fixed scheduling is that the QoE negotiations are finished with the preferred settings before the start of the streaming session. This process can be better understood with reference to the following discussion about the messages or message sequences that can be exchanged within the 3GPP network 400:

1. The PM system 402 requests and receives relevant network measurement data from local stores of the RAN 404 or CN 410 (see communications 412 in FIG. 5). The PM system 402 might be considered as a system covering the whole network 400, which includes monitoring functions, data storage, processing utilities and all functions needed to monitor performance, process the results and act if performance degradation is detected. In this case, this message or message sequence is not necessary and it is assumed that the PM system 402 already has the relevant data (including network measurements) it needs to make the decision on the sampled client terminals 406 and the level of details of QoE reports.

2. The client terminals 406 initiate new connections or terminate their existing connection to the application server 408.

3. The application server 408 sends a message to the PM system 402 requesting a QoE specification of client terminal X (see control message 415a in FIG. 5).

4. The PM node 402 sends the OMA-DM 502 a response indicating the specification of the QoE metrics for client terminal X after determining the preferred QoE metrics for client terminal X based on the conditions of client terminal X and the sampling algorithm (see control message 416a in FIG. 5).

5. Negotiation of QoE metrics occurs between client terminal X and the OMA-DM 502. These communications can be based on RTSP and SDP protocols.

6. Client terminal X sends their QoE reports to the application server 408 periodically according to the QoE metric setup that was negotiated in message no. 5. This communication is based on RTSP or HTTP depending on the system 400 (PSS, MBMS or OMA-DM).

7. The PM system 402 fetches the QoE report from the application server 408 (see messages 418a and 418b in FIG. 5).

FIG. 13's arrows do not necessarily represent single messages but message sequences related to the subject of that specification communication. The white arrows represent those messages or message sequences that exist with the traditional PM system. The dark arrows represent those messages or message sequences that have been introduced in accordance with the present invention.

The PM system 402 includes one or more processors 420 and at least one memory 422 (storage 422) that has processor-executable instructions where the processor(s) 420 are adapted to interface with the at least one memory 422 and execute the processor-executable instructions to receive messages 1 and 3 and process those messages to determine a sampling strategy and to provide client terminal X's requested QoE metrics to the OMA-DM 502 in message 4 and then receive the sampled client terminal X's QoE reports (and other sampled client terminal's QoE reports) in message 7 from the application server 408 (note: the one or more processors 420 and the at least one memory 422 can be implemented, at least partially, as software, firmware, hardware, or hard-coded logic).

The OMA-DM 502 includes one or more processors 428 and at least one memory 430 (storage 430) that has processor-executable instructions where the processor(s) 428 are adapted to interface with the at least one memory 430 and execute the processor-executable instructions to receive message 4 which indicates the client terminal X is to provide QoE reports and the requested level of detail for the QoE report from the PM system 402 and then in message 5 negotiates with client terminal X to determine metrics for the QoE reports. This enables the PM system 402 to control which client terminals 406 are to provide QoE reports and also control the level of detail in the QoE reports.

In view of the foregoing, one skilled in the art will appreciate that the PM system 402 enables network operators to make passive e2e tests focusing on a certain area. For example QoE reports can be requested by the PM system 402 from the client terminals 406 located in the same cell, from client terminals 406 of the same type, from client terminals 406 that have the same subscription type, etc. In one exemplary use case, client terminal X performs a Primary PDP Context Activation. This event is logged in the PM system 402 which contains all the data obtained from the signaling procedure which can come from the network (either interface measurements or node logs). Then, the same client terminal X initiates a connection towards the QoE enabled application server 408. The application server 408 sends a request to the PM system 402 for its QoE preference for client terminal X. Based on the QoE sampling algorithm (e.g. focusing on a certain set of cells), the PM system 402 makes a decision to request QoE reports from client terminal X and determines the level of details of the QoE reporting. The PM system 402 then sends a response to the application server 408 with the QoE specifications of client terminal X. In the QoE negotiation between client terminal X and the application server 408, the QoE report is requested from client terminal X based on the QoE preferences received from the PM system 402 (see FIG. 12). The following use-cases could also be applied by using the PM system 402 of the present invention:

UC1: test e2e performance in upgraded cells

UC2: test newly introduced user equipments

UC3: test e2e performance of users of a given subscription

UC4: test e2e performance under poor radio conditions

Although several embodiments of the present invention have been illustrated in the accompanying Drawings and described in the foregoing Detailed Description, it should be understood that the invention is not limited to the disclosed embodiments, but instead is also capable of numerous rearrangements, modifications and substitutions without departing from the present invention that as has been set forth and defined within the following claims.

1. A method for performance management in a wireless communication network having a performance management system, a plurality of client terminals, a plurality of network nodes, and an application server, the method implemented by the performance management system comprising the steps of:
selecting at least one client terminal to provide at least one quality of experience, QoE, report;
determining a requested level of detail for the at least one QoE report; and
fetching the at least one QoE report from the application server after the at least one client terminal provides the at least one QoE report to the application server.

2. The method of claim 1, further comprising the steps of:
obtaining network level measurements from the plurality of network nodes in the wireless communication network; and
utilizing at least the network level measurements to select the at least one client terminal to provide the at least one QoE report and to select the requested level of detail for the at least one QoE report which will be provided by the at least one client terminal.

3. The method of claim 1, wherein the selecting steps further include:
receiving a list from the application server indicating all of the client terminals that are currently connected thereto;
determining one or more of the currently connected client terminals that will be the at least one client terminal from which want to receive the at least one QoE report;
determining the requested level of detail for the at least one QoE report which will be provided by the at least one client terminal; and
generating a list indicating the at least one client terminal which is to provide the at least one QoE report and the requested level of detail for the at least one QoE report.

4. The method of claim 3, further comprising the step of:
sending to the application server the list indicating the at least one client terminal which is to provide the at least one QoE report and the requested level of detail for the at least one QoE report.

5. The method of claim 3, wherein the wireless communication network further includes an Open Mobile Alliance-Device Management, OMA-DM, system, further comprising the step of:
sending to the OMA-DM system the list indicating the at least one client terminal which is to provide the at least one QoE report and the requested level of detail for the at least one QoE report.

6. The method of claim 1, wherein the selecting steps further include:
receiving a message from the application server, where message includes a request for a QoE specification of a specific client terminal currently connected thereto;
determining if want to receive a QoE report from the specific client terminal;
if want to receive the QoE report, then determining the requested level of detail for the QoE report which is to be provided by the specific client terminal; and
generating a response indicating that the specific client terminal is to provide the QoE report and the requested level of detail for the QoE report.

7. The method of claim 6, further comprising the step of:
sending to the application server the response indicating that the specific client terminal is to provide the QoE report and the requested level of detail for the QoE report.

8. The method of claim 6, wherein the wireless communication network further includes an Open Mobile Alliance-Device Management, OMA-DM, system, further comprising the step of:
sending to the OMA-DM system the list the response indicating that the specific client terminal is to provide the QoE report and the requested level of detail for the QoE report.

9. A performance management system which is part of a wireless communication network also having a plurality of client terminals, a plurality of network nodes, and an application server, the performance management system comprising:
a processor; and
a memory that stores processor-executable instructions where the processor interfaces with the memory and executes the processor-executable instructions to perform the following operations:
selecting at least one client terminal to provide at least one quality of experience, QoE, report;
selecting a requested level of detail for the at least one QoE report which will be provided by the at least one client terminal; and
fetching the at least one QoE report from the application server after the at least one client terminal provides the at least one QoE report to the application server.

10. The performance management system of claim 9, wherein the processor further executes the processor-executable instructions to perform the following operations:
obtaining network level measurements from the plurality of network nodes in the wireless communication network; and
utilizing at least the network level measurements to select the at least one client terminal to provide the at least one QoE report and to select the requested level of detail for the at least one QoE report which will be provided by the at least one client terminal.

11. The performance management system of claim 9, wherein the processor further executes the processor-executable instructions to perform the selecting operations by:
receiving a list from the application server indicating all of the client terminals that are currently connected thereto;
determining one or more of the currently connected client terminals that will be the at least one client terminal from which want to receive the at least one QoE report;
determining the requested level of detail for the at least one QoE report which will be provided by the at least one client terminal; and
generating a list indicating the at least one client terminal which is to provide the at least one QoE report and the requested level of detail for the at least one QoE report.

12. The performance management system of claim 11, wherein the processor further executes the processor-executable instructions to perform the following operation:
sending to the application server the list indicating the at least one client terminal which is to provide the at least one QoE report and the requested level of detail for the at least one QoE report.

13. The performance management system of claim 11, wherein the wireless communication network further includes an Open Mobile Alliance-Device Management, OMA-DM, system, and the processor further executes the processor-executable instructions to perform the following operation:
sending to the OMA-DM system the list indicating the at least one client terminal which is to provide the at least one QoE report and the requested level of detail for the at least one QoE report.

14. The performance management system of claim 9, wherein the processor further executes the processor-executable instructions to perform the selecting operations by:
receiving a message from the application server, where message includes a request for a QoE specification of a specific client terminal currently connected thereto;
determining if want to receive a QoE report from the specific client terminal;
if want to receive the QoE report, then determining the requested level of detail for the QoE report which is to be provided by the specific client terminal; and
generating a response indicating that the specific client terminal is to provide the QoE report and the requested level of detail for the QoE report.

15. The performance management system of claim 14, wherein the processor further executes the processor-executable instructions to perform the following operation:
sending to the application server the response indicating that the specific client terminal is to provide the QoE report and the requested level of detail for the QoE report.

16. The performance management system of claim 14, wherein the wireless communication network further includes an Open Mobile Alliance-Device Management, OMA-DM, system, and the processor further executes the processor-executable instructions to perform the following operation:
sending to the OMA-DM system the list the response indicating that the specific client terminal is to provide the QoE report and the requested level of detail for the QoE report.

17. A method for performance management in a wireless communication network having a performance management system, a plurality of client terminals, a plurality of network nodes, and an application server, the method implemented by the application server comprising the steps of:
maintaining a media connected list of the client terminals connected thereto;
maintaining a quality of experience, QoE, settings list of the client terminals that have been requested to provide QoE reports together with a level of detail for the QoE reports;
maintaining a timer to control phasing out of the QoE setting list;
checking if the timer has expired;
if yes, emptying the QoE setting list;
if no, checking if a connection changed event has occurred in which a connection was opened or closed to one of the client terminals;
if yes, adding the one client terminal to the media connected list if the connection was opened or removing the one client terminal from the media connected list if the connection was closed and then sending an updated media connected list to the performance management system; and
if no, checking if received a QoE update list from the performance management system and if yes then updating the QoE settings list according to the received QoE update list.

18. The method of claim 17, wherein the adding step further includes the step of:
adding a timestamp indicating a connection initiation time of the one client terminal to the updated media connected list.

19. The method of claim 17, further comprising a step of:
removing client terminals in the media connected list based on expiry of another timer to generate the updated media connected list.

20. The method of claim 17, wherein the step of sending the updated media connected list to the performance management system further includes:
sending the updated media connected list to the performance management system after expiry of another timer.

21. An application server which is part of a wireless communication network also having a performance management system, a plurality of client terminals, a plurality of network nodes, the application server comprising:
a processor; and
a memory that stores processor-executable instructions where the processor interfaces with the memory and executes the processor-executable instructions to perform the following operations:
maintaining a media connected list of the client terminals connected thereto;
maintaining a quality of experience, QoE, settings list of the client terminals that have been requested to provide QoE reports together with a level of detail for the QoE reports;
maintaining a timer to control phasing out of the QoE setting list;
checking if the timer has expired;
if yes, emptying the QoE setting list;
if no, checking if a connection changed event has occurred in which a connection was opened or closed to one of the client terminals;
if yes, adding the one client terminal to the media connected list if the connection was opened or removing the one client terminal from the media connected list if the connection was closed and then sending an updated media connected list to the performance management system; and
if no, checking if received a QoE update list from the performance management system and if yes then updating the QoE settings list according to the received QoE update list.

22. The application server of claim 21, wherein the processor further executes the processor-executable instructions to perform the adding operation as follows:
adding a timestamp indicating a connection initiation time of the one client terminal to the updated media connected list.

23. The application server of claim 21, further comprising the step of:
removing client terminals in the media connected list based on expiry of another timer to generate the updated media connected list.

24. The application server of claim 21, wherein the processor further executes the processor-executable instructions to perform the sending operation as follows:
sending the updated media connected list to the performance management system after expiry of another timer.

25. A method for performance management in a wireless communication network having a performance management system, a plurality of client terminals, a plurality of network nodes, and an application server, the method implemented by the application server comprising the steps of:
sending a message to the performance management system, where the message contains a request for a quality of experience, QoE, specification of a specific client terminal currently connected thereto; and
receiving a response from the performance management system, where the response indicates that the specific client terminal is to provide a QoE report and a requested level of detail for the QoE report.

26. An application server which is part of a wireless communication network also having a performance management system, a plurality of client terminals, a plurality of network nodes, the application server comprising:
a processor; and
a memory that stores processor-executable instructions where the processor interfaces with the memory and executes the processor-executable instructions to perform the following operations:
sending a message to the performance management system, where the message contains a request for a quality of experience, QoE, specification of a specific client terminal currently connected thereto; and
receiving a response from the performance management system, where the response indicates that the specific client terminal is to provide a QoE report and a requested level of detail for the QoE report.

27. A method for performance management in a wireless communication network having a performance management system, a plurality of client terminals, a plurality of network nodes, an application server, and an Open Mobile Alliance-Device Management, OMA-DM, system, the method implemented by the OMA-DM system comprising the steps of:
receiving a message from the performance management system, where the message indicates at least one client terminal which is to provide at least one quality of experience, QoE, report and the requested level of detail for the at least one QoE report; and
negotiating with the at least one client terminal to determine metrics of the requested level of detail for the at least one QoE report.

28. An Open Mobile Alliance-Device Management, OMA-DM, system which is part of a wireless communication network also having a performance management system, a plurality of client terminals, a plurality of network nodes, and an application server, the OMA-DM comprising:
a processor; and
a memory that stores processor-executable instructions where the processor interfaces with the memory and executes the processor-executable instructions to perform the following operations:
receiving a message from the performance management system, where the message indicates at least one client terminal which is to provide at least one quality of experience, QoE, report and the requested level of detail for the at least one QoE report; and
negotiating with the at least one client terminal to determine metrics of the requested level of detail for the at least one QoE report.
